(19) United States
(12) Patent Application Publication
(10) Pub. No.: US 2004/0261017 A1
(43) Pub. Date: Dec. 23, 2004

(54) Document generation

(76) Inventor: Russell Perry, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/486,978

(22) PCT Filed: Oct. 25, 2002
(86) PCT No.: PCT/GB02/04819

(30) Foreign Application Priority Data
Oct. 27, 2001 (GB) 0125894.6

(51) Int. Cl. G06F 17/00

(52) U.S. Cl. 715/513

(57) ABSTRACT

A method of dynamically generating a response document (such as an XML, document) from a workflow document which comprises a plurality of a first type of workflow instructions for retrieving data, and a plurality of a second type of corresponding workflow instructions for converting the retrieved data into a plurality of markup language fragments, is described. The method comprises: processing a selected task of a workflow document using the first type of instruction of that selected task; converting the results of the precessing step into a markup language fragment using the second type of instruction of that selected task; storing the markup language fragment in a response document; and reporting the processing, converting and storing steps to create a completed response document comprising a plurality of markup language fragments.

### TECHNICAL FIELD OF THE INVENTION

The present invention concerns improvements relating to document generation. More particularly, although not exclusively, the present invention relates to the dynamic creation of a response document, for example, a Web page. The present invention has many application areas including, but not being limited to, e-commerce Web sites, Web page authoring and XML document generation.

### BACKGROUND TO THE INVENTION

The Internet is a collection of computers and computer networks that use the TCP/IP suite of protocols to communicate with one another via communication links. The Internet offers a range of different services to users, services such as email, FTP, Gopher, Telnet, and the World Wide Web. The World Wide Web (referred to hereinafter as the “Web”) is a set of interlinked documents that reside on HTTP (Hypertext Transfer Protocol) server computers that are located all over the world. These interlinked documents are known as “Web pages”, and are typically written in Hypertext Markup Language (HTML). Web pages are identified by Uniform Resource Locators (URLs) which specify the particular computer and pathname by which the Web page can be accessed.

A group of related Web pages and other elements such as files, scripts, databases and images may be combined to form a Web site. In order to view a Web site, the Web pages are transmitted from a server computer to a user computer (known as a “client computer”) using HTTP, and are displayed in a Web browser. A Web browser is a software application that lets a user locate and view HTML documents. In order to access a Web page, the user enters the URL of the Web page in the Web browser, and the Web browser locates and displays the requested Web page.

HTML is a subset of Standard Generalised Markup Language (SGML) which is a means for providing platform and application-independent documents that contain formatting, indexing and linked information. SGML provides a structure similar to a grammar whereby users can define the structure of their document and tags to be used to denote this structure. A tag is a command inserted in a document that specifies how the document, or a portion of the document should be formatted.

HTML Web pages may be created using a text editor or, alternatively, they may be created using software packages such as DreamWeaver™ or FrontPage™. These software packages enable designers to create functional and attractive Web sites without the need to know anything about the underlying programming code, except perhaps a small amount of HTML. Pages created in this manner are known as “static Web pages”. These static Web pages usually reside on servers provided by ISPs (Internet Service Providers) giving a faster and more reliable service than if the Web pages reside on a user's or a company's own server. However, if the content of these Web pages is to be changed, then the actual HTML text will have to be edited. This might involve a user editing the HTML Web pages himself and sending them back to the ISP. The disadvantage of this is that some ISP's only allow a certain number of free amendments to a Web site per year. If a user wishes to make more amendments than this, extra fees become payable.

This disadvantage may be overcome by the use of Web pages that have the ability to display dynamic content. This dynamic content may be, for example, current interest rates, weather information, travel information etc. This information is likely to be held on a database and the Web designer will have to make calls to the database in order to insert this information into a Web page. This requires a certain amount of programming knowledge. Indeed, anything other than the straightforward design of Web pages is likely to require some knowledge of programming logic that will not be available to most Web designers. This is due to the fact that the functionality of a Web site is likely to be provided by using programming languages such as Java or by using Common Gateway Interface (CGI) scripting.

CGI is a specification for transferring information between a Web server and a CGI program. A CGI program is any program designed to accept and return data that conforms to the CGI specification. The program could be written in any programming language including C, Perl, Java or Visual Basic. CGI programs are the most common way for Web servers to interact dynamically with users. Many HTML Web pages that contain forms, for example, use a CGI program to process the form's data once it has been submitted to the Web server. One disadvantage with using CGI is that every time a CGI script is executed, a new process is started at the server. This may slow the server down considerably. Another increasingly common way of providing dynamic information to Web users is to include scripts or programs that run on the client machine rather than on the Web server. These programs can be Java scripts, Java applets, or ActiveX controls. However, again these tools require a certain amount of programming logic of which a Web designer is unlikely to have in depth knowledge.

A further method of creating dynamic Web pages is by the use of programs such as servlets (i.e., small Java programs) that are provided and run on the server. The function of servlets has been extended by the use of JavaServer Pages™ (referred to hereinafter as JSP) which will now be described.

A Java Server Page is very similar to a normal HTML page, but it consists of static HTML as well as small scripts known as “scriptlets”. A scriptlet is a fragment of code that is executed when the Java Server Page is requested, and a scriptlet can therefore be used to generate the dynamic content of a page. Scriptlets have the following form: <% Java Code %>. Any code lying within these markers will be processed at the server. A JSP engine (such as a servlet) is provided on the server which interprets the JSP scriptlets and generates Web page dynamic content, e.g., by including files or accessing a database. This dynamic content is then combined with the static HTML to produce an HTML page which is sent back to a user's Web browser.

However, as a JSP is a mixture of static HTML and dynamic elements, it is very difficult to create a truly dynamic Web page. Additionally, JSP embeds Java code into HTML Web pages which poses a problem for Web designers. JSP custom tags have been developed in an attempt to overcome this problem. These tags enable Web developers to remove all Java code in theory, but this is not without the difficulty of first creating the tags or else finding an existing tag library that meets the designer's needs. Even with custom tags, it is virtually impossible to remove all Java code in a pure JSP page. Specifically, the pure JSP approach become more cumbersome when complex HTML forms are submitted to the server and the JSP has to perform validation of the form data.

A similar technology to Sun's JSP is Microsoft's Active Server Pages (ASP). ASP is a server-side scripting environment that can be used to create interactive Web pages and build Web applications for use in, for example, electronic commerce. More specifically, ASP's are text files that contain not only text and HTML tags (as in standard Web pages), but also commands written in a scripting language (i.e., a simple programming language designed to perform special or limited tasks) such as VBScript or JavaScript). When the server receives a request for an ASP file, it processes these script commands at the server to build a Web page that is then sent to the Web browser for subsequent display. The disadvantage of using ASP to create dynamic Web pages is that if VBScript is used, this scripting code is written in Visual Basic and it cannot be run on every server. In addition to this, there is not the complete separation of programming logic from the formatting of the Web page content.

A method of using a script written in the script language XSP (XML server pages language) to generate style and content for an XML document is described in GB 2 359 645 A (Dell Products L.P.). The script language includes control statements for generating a first document specifying content to be included in the XML document, and for generating a second document specifying the style of the content in the XML document. As this method produces only a single content document, and a single styling document, control logic has to be included in the script in order to control how the content is styled. In addition to this, XML and XSL instructions are embedded within the XSP scripts. A Web designer using this method would therefore still require a certain amount of programming knowledge in order to produce a well-styled XML document.

This problem of separation of data, presentation, and programming logic has always been an issue for Web developers, though the above described attempts at solutions all have difficulties.

Accordingly, there is a requirement for a method of dynamically generating documents such as Web pages wherein the design of the layout of the page is completely independent from the underlying programming logic of the page.

### SUMMARY OF THE INVENTION

According to a first aspect of the present invention there is provided a method of dynamically generating a response document from a workflow document which comprises a plurality of a first type of workflow instructions for retrieving data, and a plurality of a second type of corresponding workflow instructions for converting the retrieved data into a plurality of markup language fragments, the method comprising: processing a selected task of a workflow document using the first type of instruction of that selected task; converting the results of the processing step into a markup language fragment using the second type of instruction of that selected task; storing the markup language fragment in a response document; and repeating the processing, converting and storing steps to create a completed response document comprising a plurality of markup language fragments.

According to a second aspect of the present invention there is provided a system for dynamically generating a response document from a workflow document which comprises a plurality of a first type of workflow instructions for retrieving data, and a plurality of a second type of corresponding workflow instructions for converting the retrieved data into a plurality of markup language fragments, the system comprising: processing means for processing each of the first type of workflow instructions to generate a corresponding output; conversion means for executing each of the corresponding second type of workflow instructions to convert each of the outputs of the processing means into one of the plurality of markup language fragments; and a data store for storing each of the plurality of markup language fragments generated by the conversion means in the response document.

According to a third aspect of the present invention there is provided workflow document for use in a method and/or a system described above, the workflow document comprising: a plurality of workflow tasks, each task comprising a first type of workflow instruction for retrieving data, and a corresponding second type of workflow instruction for converting the retrieved data into a markup language fragment.

The construction of a document written in a markup language (such as a Web page, for example) can thus be reduced to the assembly, execution and then conversion rendering of multiple workflow tasks. Furthermore, the programming elements (dynamic content) can be completely separated from the design elements (formatting of the Web page dynamic content). This enables Web designers to change the appearance of the dynamic content of a Web page (or other document written in a markup language) by simply changing the second type of instruction without having to modify all of the dynamic programming part of the Web page generating instructions.

Also, the separation of the dynamic Web content generating instructions in this way enables the Web designers to work completely independently of the Web programmers thereby shortening overall Web site development time. Furthermore, if libraries of the second type of instruction are created, Web designers can simply select required dynamic styles to be applied to the dynamic Web content obtained by the associated first type of command.

The workflow document is preferably processed by a workflow processor, which most preferably is accessed through a servlet that resides on a server. A workflow processor is a small program that sits on the server and interacts with the servlet, preferably via a message queue. Processing of a workflow document preferably includes parsing the workflow document, extracting the first type and second type of workflow instruction, followed by execution of the first type of workflow instructions to retrieve data. This data may comprise Web page content. The parsing may be achieved using XML parsers such as Xerces, or Crimson for example, which are available from the Apache organisation. The data retrieved is preferably embedded in intermediate code. This intermediate code may be markup code such as XML. The intermediate code is then converted into a markup language fragment (the markup language preferably being understood by a Web browser) by executing the second type of workflow instruction. The response document is then preferably returned to the client for display (or further processing) on a client machine in a client-server environment. This response document is preferably written in a language that is understood by a Web browser, such as HTML. However, the method need not be carried out in a client-server environment: it may be carried out on a personal computer that is not part of a network, or on any other suitable computing environment.

The workflow tasks contained within the workflow document are preferably executed in the order in which they appear in the workflow document. However, they may be executed in a different order.

The first and second workflow instructions are preferably written in a markup language. Most preferably, the workflow instructions (and the workflow document as a whole) are written in eXtensible Markup Language (XML). The first type of workflow instruction will be referred to hereinafter as an XML instruction, although the instruction may be defined using another workflow language.

The combination of the intermediate code and the data retrieved by the execution of an XML instruction is hereinafter referred to as an XML fragment.

XML is a relatively new markup language based on SGML that is designed to make information “self-describing”. XML consists of rules that can be used to create a user defined markup language. One XML rule is that tags must always be used in pairs and must surround the data that the tag refers to. Another rule is that tags can be nested inside one another so as to form a tree. XML can thus not only be processed and understood by a computer program, but it can also be understood by a user as it is written in ordinary text. XML enables designers to create their own customised tags to produce their own application-specific document types. In addition XML supports richer functionality than HTML by, for example, supporting links that point to multiple documents, as opposed to HTML links which are able to reference just one other document.

XML documents are structured as trees which consist of nodes. Each node can contain other nodes. Each of these ‘contained’ nodes is defined as a child node. Each of these contained nodes may similarly have child nodes, and so on. For example:

```
<?xml version=“1.0”?>
  <A>
    <B>
      <C>
        <D>
        </D>
      </C>
    </B>
  </A>
```

In this example, A is the root node, B is a child node of A, C is a child node of B, and D is a child node of C.

As stated previously, Web pages are mostly written in HTML. HTML uses predefined tags such as <p> (which denotes the start of a paragraph) and <b> (which denotes bold text) in order to format the information in a Web page. The meaning of these tags is well understood by the Web browser. With XML, any tags at all can be used. However, the meaning of these tags will not automatically be understood by the Web browser. For example, <table> could mean an HTML table, or if used in a document written in XML, it could mean a piece of furniture.

As XML tags are user-defined, there is no standard way of displaying an XML document. A method is therefore required of describing how the document should be displayed. One method of instructing how an XML document is to be displayed is through the use of “style sheets” such as Cascading Style Sheets (CSS) and eXtensible Style sheet Language (XSL). XSL files are themselves written using XML.

XSL consists of two parts: a method of transforming XML documents, and a method of formatting XML documents. That is, XSL can transform XML into HTML or XHTML (XHTML is a reformulation of HTML 4.0 as an application of XML instead of SGML) so that it can be displayed by a Web browser; and XSL can also format the data in the XML document based on the value of the data. A schematic block diagram showing the steps involved in the transformation of an XML document into an output document of a different format which is known in the prior art is shown in FIG. 1a.

Each XML fragment is converted by a second type of instruction into a markup language fragment (the markup language preferably being understood by a Web browser) preferably by specifying a transform to apply to the XML fragment. The second instruction specifies which transformation is to be applied to the XML fragment. Preferably, this transform is an XSL transform known as XSL-T. Most preferably the XSL-T is defined within an XSL-T document or stylesheet. However, it may be desirable to specify alternative transformation types other than just XSL transformations. For example, the second type of instruction may specify an operation. This operation may be specified by an XQuery instruction which allows an XML document to be queried and to produce an XML document as the output. In the following example there are shown two workflow tasks, the first task including a first instruction for retrieving XML data, and a second instruction specifying an XQuery instruction:

```
<item>
    <XML loc=“file:/localDisk/books.xml” .../>
    <XQUERY loc=“file:/localdisk/queryBooks.xml”
    output=“tmpl.xml” ... />
</item>
<item>
    <XML loc=“tmpl.xml” type=“var” ... />
    <XSL loc=“file:/localdisk/displayResults.xml” ... />
</item>
```

The second instruction of the first workflow task queries the books.xml document producing a document which is stored under the name tmp1.xml. This is then transformed using an XSL-T document specified by the second workflow task to an HTML document to display the results. The document books.xml is shown below.

```
<bib>
    <book year=“1994”>
        <title>TCP/IP Illustrated</title>
        <author><last>Stevens</last><first>W.</first></author>
        <publisher>Addison-Wesley</publisher>
        <price>65.95</price>
    </book>
    <book year=“1992”>
        <title>Advanced Programming in the Unix environment</title>
        <author><last>Stevens</last><first>W.</first></author>
        <publisher>Addison-Wesley</publisher>
        <price>65.95</price>
    </book>
    <book year=“2000”>
        <title>Data on the Web</title>
        <author><last>Abiteboul</last><first>Serge</first></author>
        <author><last>Buneman</last><first>Peter</first></author>
        <author><last>Suciu</last><first>Dan</first></author>
        <publisher>Morgan Kaufmann Publishers</publisher>
        <price>39.95</price>
    </book>
    <book year=“1999”>
        <title>The Economics of Technology and
        Content for Digital TV</title>
        <editor>
            <last>Gerbarg</last><first>Darcy</first>
            <affiliation>CITI</affiliation>
        </editor>
          <publisher>Kluwer Academic Publishers</publisher>
        <price>129.95</price>
    </book>
</bib>
```

An example query could be given by “List books published by Addison-Wesley after 1991, including their year and title” which is given by:

```
<bib>
    {
    for $b in document(“http://www.bn.com”)/bib/book
    where $b/publisher=“Addison-Wesley” and $b/@year>1991
    return
        <book year=“{ $b/@year }”>
        { $b/title }
        </book>
    }
</bib>
The above query yields the result:
<bib>
        <book year=“1994”>
            <title>TCP/IP Illustrated</title>
        </book>
        <book year=“1992”>
            <title>Advanced Programming in the
            Unix environment</title>
        </book>
</bib>
```

The second type of workflow instruction may specify other types of operations such as validation (a Web designer may wish for example to check that a document is correctly filled in or conforms to some specified syntax), and inserting a digital signature into retrieved data.

The XML instruction specifies the data to be retrieved, and how that data is to be accessed or generated. Accordingly, an XML instruction preferably consists of a “resource type” specifier and a “location” that points to the place that the resource is stored (a resource being any software component that is capable of returning an XML fragment). For example, a resource type may be a file and the location would be the location of this file specified, for example, by a URL.

In addition to calling a file, an XML instruction may make, for example, a call to a database to retrieve data, make a request for static text or syndicated content (i.e., content obtained from a third party such as an Image database provider). The XML instruction could also be used to obtain state information about a user's interaction with a Web site or page. For example, it could be an instruction to specify that an HTML form filled out by a user needs to be processed. Taking the example of a database call, the XML instruction would call a function that makes a call to a database and gets XML intermediate code to “wrap round” the information returned from the database to give an XML fragment.

A call to a database may be carried out directly or via a component such as an Enterprise Java Bean (EJB) which is a software component that has a standardised interface. The advantage of using EJB's is that much of the “house-keeping” code is handled by the EJB container which improves the productivity of the Web developer.

An XML instruction may additionally specify a “name”. Such a workflow instruction is shown below embedded in a workflow document:

```
<?xml version=“1.0”?>
<workflow>
<task>
    <XML resourcetype=“STATIC” loc=
    “C:\fragment.xml” name=“XYZ”/>
    <XSL loc=“C:\fragment.xsl”/>
</task>
</workflow>
```

If a name is specified, then a new child element is appended to the response document root node with the specified name, and the output of the XSL transformation is inserted into that new child node. This is illustrated as follows:

```
<?xml version=“1.0”?>
<root>
    <XYZ>
        <transformed fragment.xml document here>
    </XYZ>
</root>
```

If no name is specified, the output of the XSL transformation is appended directly as a child of the response document root node, as follows:

<?xml version=“1.0”?>
<root>
<transformed fragment.xml document here>
</root>.

An XML instruction may also be used to call another workflow document. A particular feature of the invention is the ability to reference one workflow document (i.e., a “child” workflow document) from within another workflow document (the “parent” workflow document). This enables workflow documents to be reused in a modular, hierarchical fashion saving time and money when creating Web pages dynamically. There is preferably also provision in the present invention for specifying which users can execute particular workflow documents. The workflow documents may also support conditional statements such as if . . . else statements, if desired.

In a client-server environment, XML instructions are most preferably executed at the server-side of the client-server environment. They may, however, be executed at the client-side. The reason for executing XML instructions at the client-side of a client-server environment is that XSL-T transformations are potentially computationally expensive and this can reduce the response times to response document (such as a Web page) requests if the server is heavily loaded. To redistribute the load, the workflow document may be executed at a purpose-built client. The workflow execution would be very similar to that described previously except for two differences. Firstly, the client would need to request each XML fragment from the server. Secondly, the client would also need to request the XSL-T stylesheets from the server. The request for all XSL-T stylesheets and XML fragments could be implemented using a simple protocol. The client would be responsible for the transformation of the XML fragments and the construction of the response document.

The workflow tasks may specify the order in which the task is carried out. The workflow task may also specify whether or not the task may be carried out asynchronously, as illustrated below:

```
<item async=“true”>
    <XML loc=http://remoteServer1/remotedoc.xml” .../>
    <XSL ....>
<item>
<item asynch=“true”>
    <XML loc=http://remoteServer2/remotedoc.xml” .../>
    <XSL>
</item>
```

It may take a relatively long time to transfer a remote document. Thus by marking the above two workflow tasks as asynchronous (i.e. asynch=“true”), it allows the instructions to be carried out substantially in parallel. As soon as the remote document is returned it is processed using the transform specified in the second instruction of the corresponding task This approach is much quicker than waiting for each of the remote documents to be sent back in turn.

It is preferable that the XML fragments conform to a standard device independent language in order to support reuse of the XSL-T fragments. This is because XSL-T is sensitive to changes in the structure of the XML documents it is written to process: if the XML document structure is changed, the XSL-T may also need to be changed to produce the desired styling and formatting effect. Frequent editing of XSL-T code would be time consuming and costly. It is therefore advantageous that a markup language is specified for the XML fragments. The exact form this takes can be determined by the house rules of the organisation deploying the server. An example of such a language is given as follows.

In this example, the following four XML element types are defined: “Group Element”, “Container Element”, “Complex Element”, and “Leaf Element”. Here, Group Element is the root node, a Container Element is a child node of a Group Element, a Complex Element is a child node of a Container Element, and a Leaf Element is a child node of a Complex Element. So, for example, an XML Group Element may be an HTML table formed from a number of table rows (container element). Each table row may be comprised of a number of table cells (complex element), and each table cell may contain a text item (a leaf element). The table below gives an example of HTML elements that can be formed by transforming the XML elements using an XSL-T transform or other suitable transform.

| Parent Class | HTML element |
|---|---|
| GroupElement | Page, Table, Ordered List |
| ContainerElement | Table Row, List Item |
| ComplexElement | Section, Table Cell, Paragraph |
| LeafElement | Image, Text |

As the markup language defined above does not prescribe any particular layout or style information, it is also possible to render the XML elements as a list simply by changing the XSL-T code. Thus the look and feel of the response (HTML) document created by the workflow processor is determined by the XSL-T transformation. The advantage of this is that if the XSL-T stylesheets (and thus transformations) are changed, the appearance of the HTML output can be changed without modifying the XML fragment structure, or the XML instructions used to generate these XML fragments. For example, a transformation could be provided to transform the above XML elements into wireless markup language for mobile communications.

The XSL-T approach for Web page generation has clear advantages over traditional approaches. It has the distinct advantage that its constituent parts are clearly segregated, i.e., the styling is separated from the program logic and content. From a project management perspective, this allows every project member to work in parallel, rather than overloading the Web programmers while the Web designers are left waiting for the more complex code to be produced before starting or completing their tasks. This saves both time and money. Another advantage of the invention is that the XSL-T code can be re-used. This can be done either internally within a company or as part of a broader Web community effort. Another advantage of using XML/XSL-T fragments is the ability to more easily support device independent authoring of Web pages.

The major disadvantage of the XSL-T approach is runtime performance. For most applications, runtime performance is fast enough, but, if performance is unsatisfactory, a more advantageous approach is to parse the XSL-T style sheet into memory once, and then preserve the stylesheet in memory for repeated use. This is approach taken in the embodiment of the workflow processor described herein.

The workflow document is advantageously created by a designer. If the response document is to be used as a Web page, then the designer may be a Web designer. The designer may have access to a repository of XML fragments and XML instruction definitions, and a repository of XSL-T transformations to format and style the XML fragments. The workflow document may then be created by the designer specifying at least one workflow task comprising an XML instruction and its respective XSL-T transform. The designer may also develop these XSL-T transforms. A Web programmer/software developer is preferably responsible for writing the code to generate the XML fragments from the XML instructions. The structure of these XML fragments would preferably be agreed by the designer and the programmer/developer preferably using a device independent markup as described previously.

The XSL-T transforms may be developed completely independently of any servlet or database code by using static XML files. However, not every XML code fragment needs to be transformed by an XSL-T code fragment. This supports embedding of XML code fragments that have already been rendered into a form that is understandable by a Web browser or other suitable application.

The advantage of using a workflow document is that no programming logic is included in the workflow documents. Programming logic does not easily scale up from small to large documents (the logic may have to be rewritten for a large document) and is also hard to maintain.

A workflow task may include a first XML instruction, and multiple XSL instructions. For example, if the workflow task comprises two XSL instructions the workflow processor would interpret this workflow task in the following manner. The XML instruction would be executed and a first XML fragment F1 retrieved. Fragment F1 is then transformed using the first XSL instruction. The output of this transformation is another XML fragment F2. F2 is then transformed by the second XSL instruction to produce a third XML fragment F3 which is inserted into the response document. For example, the workflow task may be specified as follows:

```
<item>
    <XML loc=http://someWebSite:8080/source.xml .../>
    <XSL loc=“file:/localdisk/transform1.xsl” ... />
    <XSL loc=“file:/localdisk/transform2.xsl” ... />
        ....
    <XSL loc=“file:/localdisk/transformN.xsl”/>
</item>
```

The transform transform1.xsl would be applied to source.xml (available at the remote Web site someWebSite), and the output would be operated on by transform2.xsl and so on. A reason for doing this is to first convert an external XML document into an in-house format and then to transform it into, say a table in HTML. An advantage of this is that the second transform can then be reused again and again: every time a new data source is brought in from an external site then a new transform1.cml can be written to convert to the in-house format.

As workflow documents may themselves be XML documents, the method of the invention can be advantageously used to dynamically generate a second workflow document from a first, pre-written workflow document. The second workflow document can then be processed by the workflow processor in order to generate, for example, HTML pages. For example, different makes and versions of Web browsers display data in different ways. Web designers and programmers will probably not know in advance the particular Web browser that a user will be using. A pre-written workflow document calls an XML instruction that dynamically generates a new workflow document which contains an XSL formatting instruction for the user's particular browser. This new workflow document would then be executed to produce an HTML Web page. It would also be possible to personalise workflow documents before passing them to the workflow processor for execution.

The method of the invention may be used to generate a complete Web site. Preferably each Web page of the Web site is created by executing a single workflow document. In order to differentiate calls to different workflow documents belonging to the same Web site, the header of the HTTP request sent to the server by the Web browser advantageously contains a workflow document identifier. For example, a URL such as http://Iocalhost:8080/servlet/servletName?WfID=N where N is a unique identifier which may be used to identify the workflow document of interest. The servlet is then responsible for extracting this unique identifier from the HTTP request. The servlet may also contain a table to map the workflow identifier to the place where the workflow document is stored. The workflow document may be stored on the same server as the servlet. Alternatively, the workflow document may be stored on a remote server or database. Multiple servlet requests may be processed in parallel.

A Web site can be thought of as a logical collection of workflow documents connected via hyperlinks in the Web pages. It is sometimes desirable to link to the same content or data via different hyperlinks in a Web page. Preferably hyperlinks in Web pages which are to be generated from a workflow document are inserted into the XML fragments before the XSL-T transformation process takes place. This is illustrated in FIG. b. These hyperlinks may be internal workflow links (i.e., links to other workflow documents that are part of the same Web site as the workflow document), external workflow links (i.e., links to a workflow document that belongs to a different Web site), and external links (i.e., a link to a non-workflow document). This separation of hyperlinks from the content of a Web site provides a further advantage of the invention. That is, a single content file can be used in different contexts by utilising different hyperlinks, rather then having to create two separate content files with different links embedded inside them. It is also easier to manage the hyperlinks in a Web site when they are separated from the content.

This hyperlink information is advantageously stored in a separate configuration file that is retrieved as the workflow document is being processed by the workflow processor. The configuration file is preferably stored on the server.

The method of the present invention may also provide for error handling during the processing of the workflow document by, for example, inserting an error code into the document generated by the method, the error code indicating where in the workflow document the error occurred and/or the type of error.

The present invention also extends to a method of designing a dynamic response document such as a Web page, the method comprising creating a workflow document including a plurality of workflow tasks, wherein the creating step comprises specifying a plurality of first type of workflow instructions for retrieving data and a plurality of second type of corresponding workflow instructions for converting the retrieved data into a corresponding plurality of commonly understood format language fragments. Preferably, the specifying step comprises selecting a first type of workflow instructions or a second type of workflow instructions from a predetermined library of such instructions.

The present invention may also be considered to cover a data carrier comprising a computer program arranged to configure a computer to implement the method and/or system of the invention as described above.

### BRIEF DESCRIPTION OF DRAWINGS

A presently preferred embodiment of the invention will now be described, by way of example only, with reference to the accompanying Figures, in which:

FIG. 1a is a schematic block diagram showing the formatting of XML code using an XSL-T stylesheet, according to the prior art;

FIG. 1b is a schematic block diagram showing a method of adding links to a response document that is generated by an embodiment of the present invention;

FIG. 2 is a schematic diagram showing a client-server system suitable for implementing the presently preferred embodiment of the present invention;

FIG. 3 is a schematic diagram of a workflow document used in the present embodiment;

FIG. 4 is a hybrid flow diagram showing the method of processing a workflow document to produce a Web page according to the present embodiment of the invention;

FIG. 5 is a flow diagram illustrating in more detail Steps 103 to 110 of the method shown in FIG. 4;

FIG. 6 is a flow diagram the processing step of the method shown in FIG. 4;

FIG. 7 is a diagram showing nested workflow documents that can be generated by the present embodiment;

FIG. 8 is a schematic diagram showing the generation of a workflow document by a Web designer according to the present embodiment;

FIG. 9 shows a prior art Java Server Page source code for generating a form;

FIG. 10 is a schematic diagram showing the Web page generated by the source code of FIG. 9;

FIG. 11 shows an XML fragment generated by a workflow document according to the present embodiment to provide the content for the table displayed in the Web page shown in FIG. 10;

FIG. 12 shows a segment of XSL-T code used to format the XML fragment of FIG. 11; and

FIG. 13 shows HTML code generated by the workflow document of the present embodiment to produce the table displayed in the Web page shown in FIG. 10.

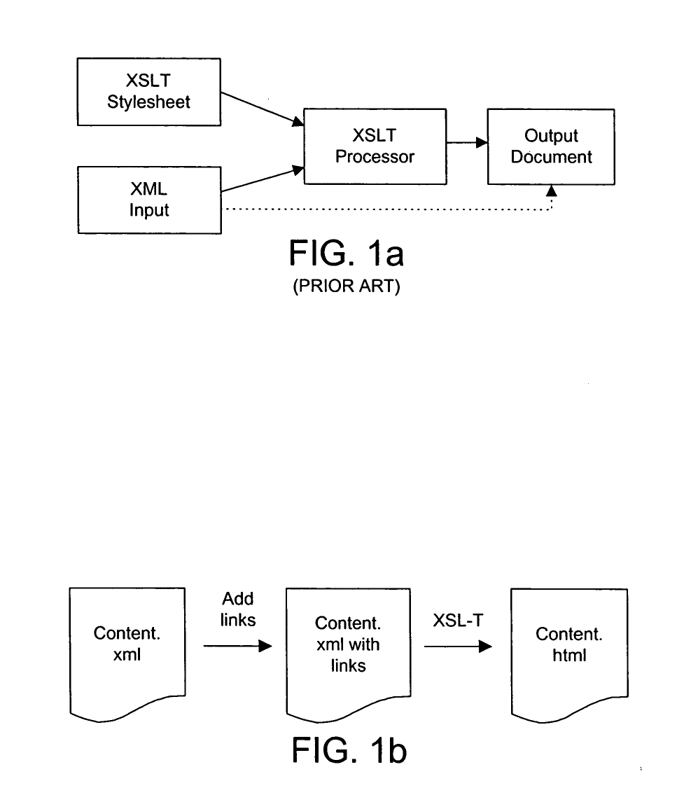

### DETAILED DESCRIPTION OF PREFERRED EMBODIMENT

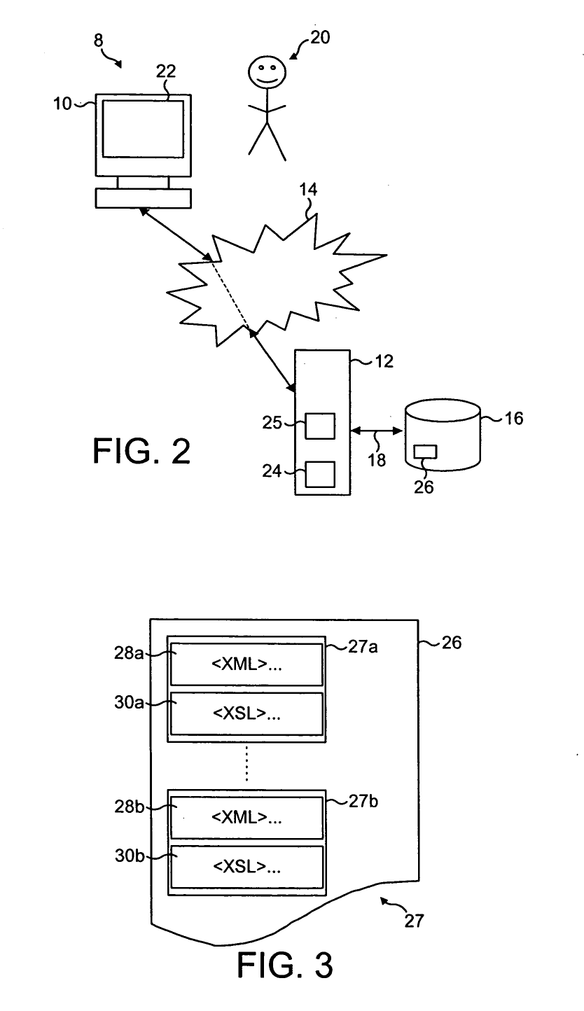

Referring to FIG. 2 there is shown a client-server system 8 known in the prior art which is suitable for implementing the invention. The client-server system 8 comprises a client computer 10 which is connected to a server computer 12 via the Internet 14. The server 12 is optionally connected to a database 16 by way of a further connection 18. The arrows in FIG. 2 indicate that data can be exchanged in both directions between the client computer 10 and the server 12, and between the server 12 and the database 16. In order to enable a user 20 to navigate through the Internet to different servers and Web sites, the client computer 10 has an Internet or Web browser 22 provided. At the server side of the system 8, a servlet 24 running on the Web server 12 is provided, together with a workflow processor 25.

With reference to FIG. 3 of the drawings, there is shown a schematic diagram of a document 26 which is known as a “workflow document”. Only the outline structure of the workflow document is shown. The workflow document is located at the server side of the client-server system 8, as shown in FIG. 2. This document 26 contains a number of workflow tasks 27. Each workflow task 27 contains an XML instruction 28 for retrieving an XML fragment together with a respective XSL-T formatting/conversion instruction 30. The diagram of FIG. 3 explicitly shows first and second workflow tasks 27a,27b with their respective first and second XML instructions 30a and 30b, and corresponding first and second XSL-T formatting instructions 28b and 30b. However, the workflow document may contain any number of workflow tasks 27. As the XSL-T formatting instructions 30a,b are also written in XML, the workflow document 26 is itself an XML document.

This workflow document is used to produce a Web page 32 dynamically at the server 12. The method by which this is done is now described.

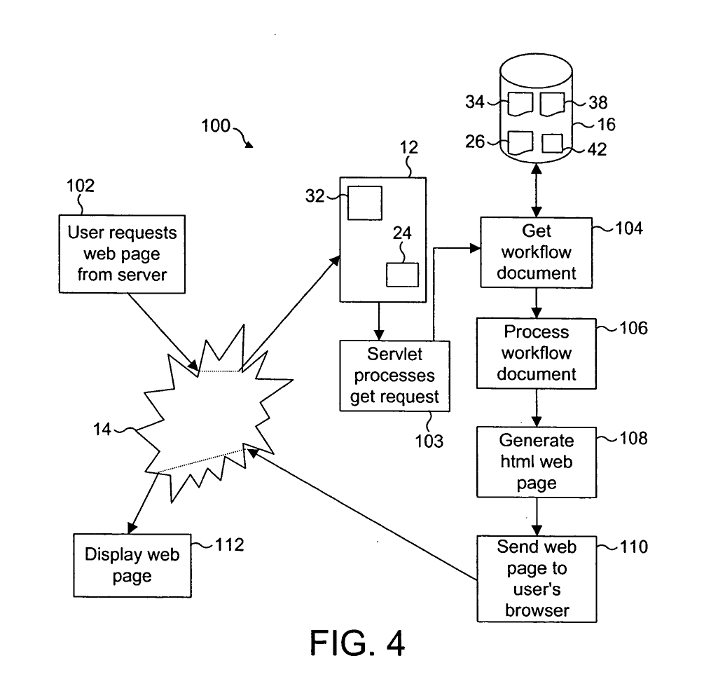

With reference to FIG. 4 of the drawings, there is shown an overview of a method according to a preferred embodiment of the present invention. The method 100 commences with the user 20 requesting at Step 102 a Web page 32 from the server 12 by entering the URL of a Web page (not shown) into the Web browser 22. The Web browser 22 sends a GET request to the server 12 via the internet 14 in order to get the requested Web page. The servlet 24 that is provided on the server 12 then processes at Step 103 this GET request and retrieves at Step 104 the stored workflow document 26. The workflow document 26 is shown as residing on the database 16 connected to the server 12. It may, however, reside on the server 12, or on remote server (not shown).

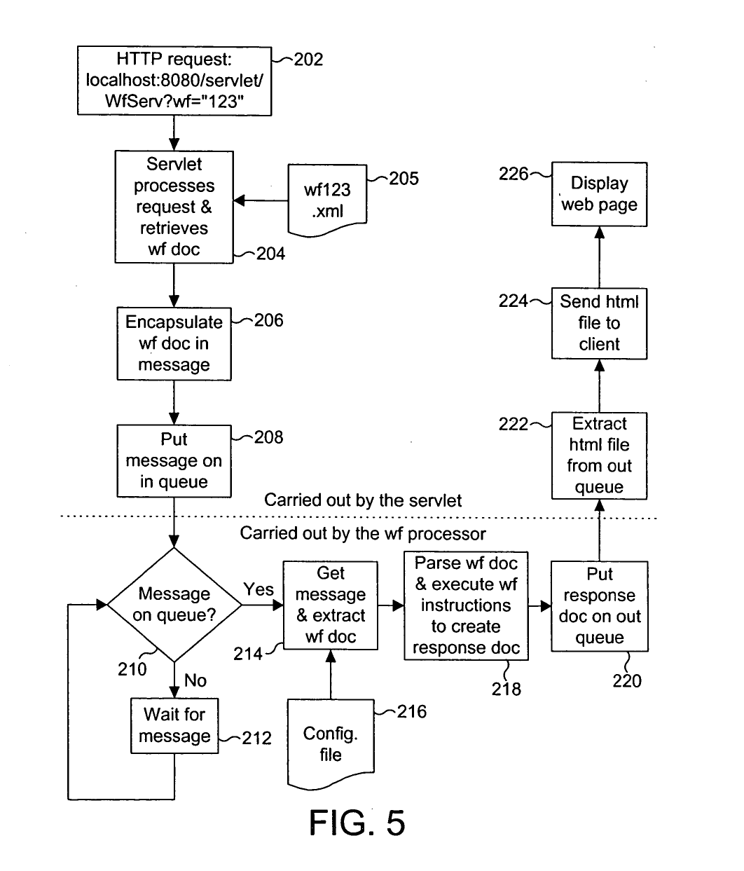

The workflow document 26 is then processed at Step 106 by the workflow processor 25 in order to generate at 108 an HTML file 42. This HTML file 42 is then sent at 110 to the client machine 10, whereupon it is displayed at 112 as a Web page 32 by the user's Web browser 22. Steps 103 to 110 of the method 100 are now described in more detail with reference to FIG. 5.

Firstly, the servlet 24 receives at Step 202 the HTTP request from the Web browser 22. The HTTP request is sent to “localhost:8080/servlet/WorkflowServ?workflow=“123” which calls workflow document number 123. The servlet processes at Step 204 this request and retrieves at Step 205 the workflow document number 123. The HTTP request used to retrieve the workflow document may be an alias so that the user 20 is not aware that he is requesting a workflow document 26 rather than an HTML Web page. This workflow document 26 is then encapsulated at Step 206 inside a message, and the message is subsequently placed at Step 208 onto a workflow inbound message queue.

In parallel with the servlet's operation, the workflow processor 25 listens repeatedly at Step 210 for messages to be placed on the workflow in-bound message queue. If there is a message on the queue, the workflow processor 25 reads at Step 214 the first message on the in queue, and extracts at Step 214 the workflow document number 123 from the message. However, prior to these reading and executing steps, the workflow processor is initialised. During its initialisation, the workflow processor 25 reads at Step 216 a configuration file. The configuration file contains information for the workflow processor 25 such as hostnames, server port numbers, document source locations, and other site maps etc. This information is required to enable the workflow processor 25 to generate URL links to other workflow documents and sites. If the site administrator wishes to, for example to run the servlet and workflow processor on another machine then only this configuration file needs to be edited.

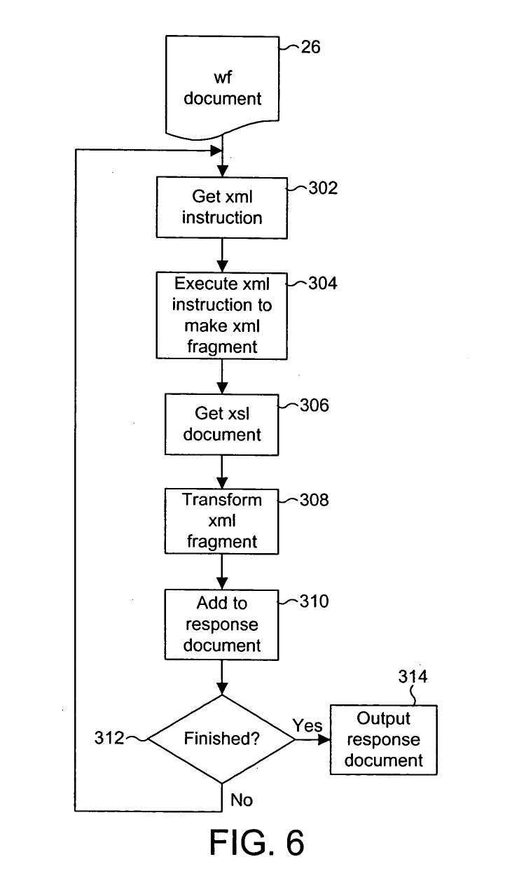

The workflow processor 25 then processes at Step 218 the extracted workflow document. The processing involves parsing the workflow document 26 and executing the workflow tasks 27 therein in sequence. The steps taken in the processing of the workflow document 26 are illustrated by FIG. 6 and are now explained below.

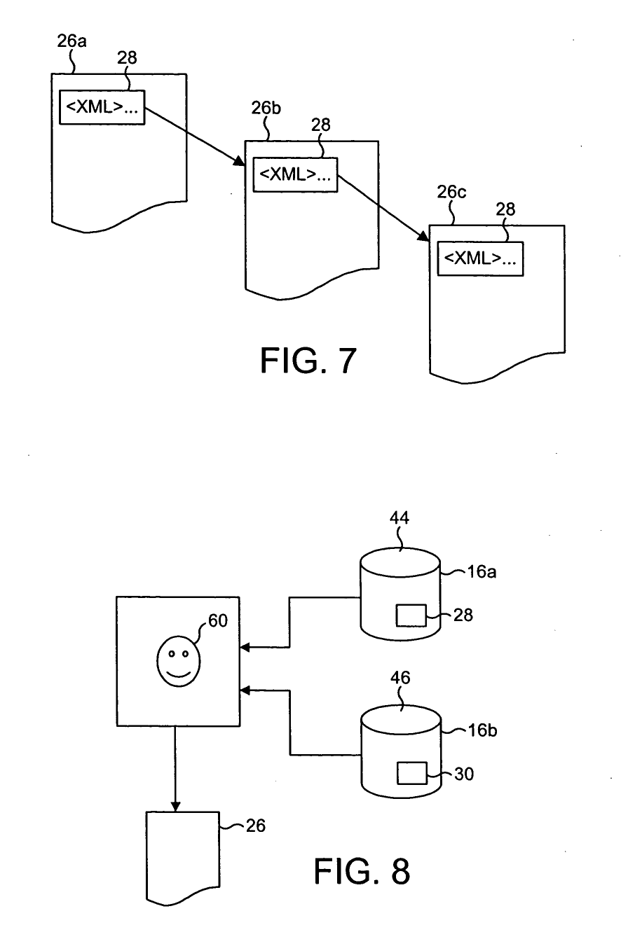

Referring to FIG. 6, the workflow processor 25 gets at Step 302 the first workflow task 27 from the parsed workflow document and reads the first XML instruction 28a. This XML instruction is then executed at Step 304 by the workflow processor 25. The XML instruction 28 may be used to retrieve dynamic content for inclusion in a Web page 32 by making a database call. In this case, the XML fragment returned by the XML instruction will contain information obtained from the database embedded in XML code. An XML instruction 28 can also be used to retrieve static XML code 34 located on a different server or database. In a further example, an XML instruction 28 can be executed to obtain syndicated content 38 which is also embedded in XML intermediate code. An XML instruction 28 can also be used to retrieve another workflow document. This is illustrated by FIG. 7. In this Figure, three nested workflow documents 26a, 26b and 26c are shown. A first XML instruction 28a in workflow document 26a calls the second workflow document 26b. The first XML instruction 28b in this workflow document can then make a call to the third workflow document 26c. The process may end at this step, or the XML instruction in this third workflow document 26c may make further calls to workflow documents and/or retrieve further XML fragments.

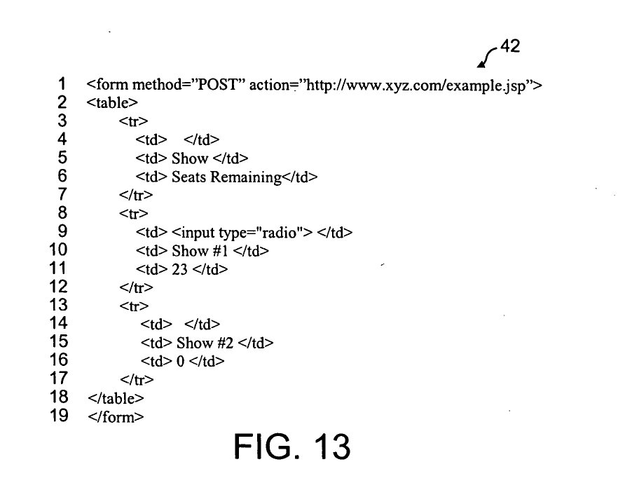

Returning to FIG. 6, after executing the first XML instruction 28a and thereby producing an XML fragment, the workflow processor 25 gets at Step 306 the respective XSL-T formatting instruction. This XSL-T code is used at Step 308 to format the XML fragment produced by executing the XML instruction 28. Next, the formatted data is written at Step 310 to an HTML file 42 (see FIG. 13). The servlet 24 then checks at Step 312 whether all the XML tasks 27 have been executed. If there are remaining XML tasks to be executed, Steps 302 to 310 are repeated until all of the tasks have been dealt with. Then, the completed HTML file 42 is output at Step 314 to the out message queue.

Returning now to FIG. 5, after the dynamically generated HTML file 42 has been put (at Step 220) onto the out message queue by the workflow processor 25, the servlet 24 is alerted to retrieve the message from the queue. If there is a message on the queue, the servlet extracts from the queue at Step 222 the generated HTML file 42. This HTML file is then sent at Step 224 to the client 10 via HTTP. The HTML file is then displayed at Step 226 by the client computer's Web browser 22 and is seen by the user as a “normal” Web page 32.

The process of creating a workflow document 26 for use with a preferred embodiment of the present invention will now be explained with reference to FIG. 8. A Web designer (60) has access to two repositories 44 and 46 (shown as databases 16a and 16b). The first repository 44 is a database or file store that contains details of XML fragments and the mechanism 28 by which they can be obtained. For example as described previously, the instructions 28 may make database calls, retrieve other workflow documents 26, retrieve static text etc. These instructions 28 are pre-written by Web programmers or developers (in consultation with the Web designer) who have an in-depth knowledge of Web technologies and the way that the Internet functions.

The second repository 46 is a database or file store that contains a library of XSL-T formatting instructions 30 that are pre-written in XML. These XSL-T documents are likely to be written by the Web designer.

In order to produce a workflow document 26 suitable for generating a Web page 32 for display on a Web browser 22, the Web designer creates a new workflow document and inserts XML instructions into the document 25 and specifies the XSL-T document to use to transform each XML fragment returned by execution of the XML instruction. Thus, for example, if the first XML instruction 28 is a call to a database to obtain the details about spare theatre tickets for West End shows, the corresponding XSL-T formatting instruction will describe how this data is to be displayed in a Web page 32.

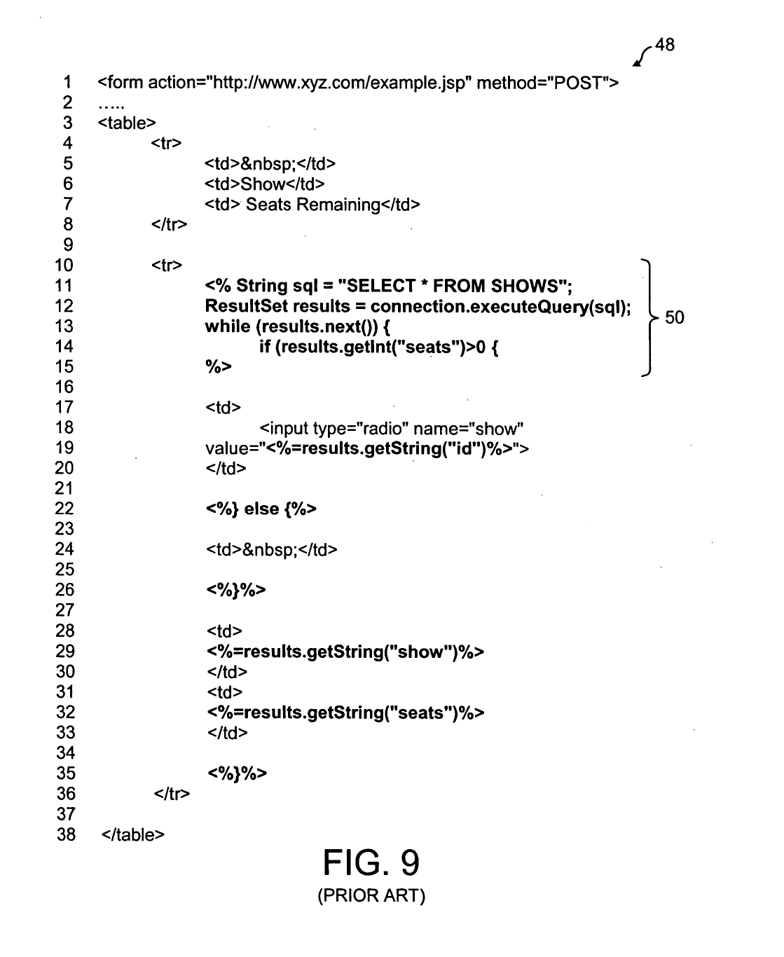

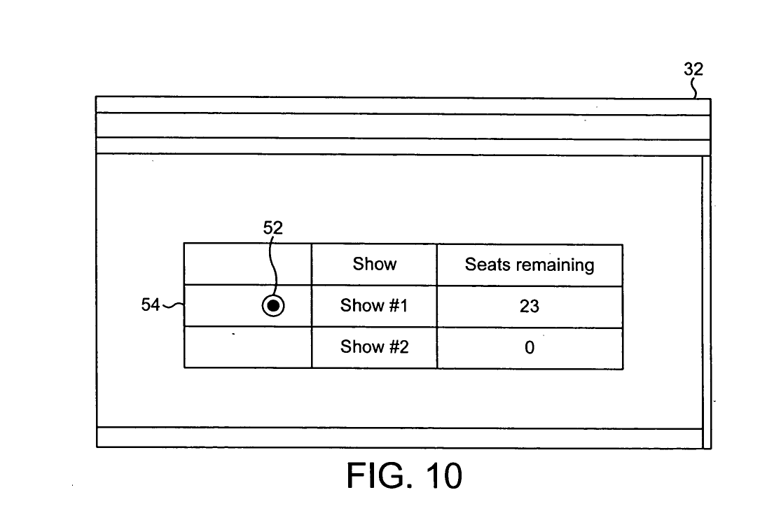

An example of the use of a preferred embodiment of the present invention is now described. This example relates to making a database call, and displaying the resulting data as a form 54 on a Web page 32 displayed in a Web browser 22. Firstly, the source code of part of a JSP page 48 is discussed to better illustrate the advantages of the present invention. The source code is shown in FIG. 9. It can be seen from this Figure that the JSP page 48 contains static HTML code (shown in normal type) and a JSP expression 50 written in the Java programming language (shown in bold type). Processing of the JSP page 48 at the server 12 produces the HTML Web page 32 shown in FIG. 10.

The JSP source code will now be looked at in detail. Line one of the code informs the Web browser 22 that the Web page 32 is to be displayed as a form that can be filled in and posted to the server 12. It also includes the name of the JSP page (“example.jsp”). Line three of the code tells the browser 22 that the form is to be displayed as a table 54. The HTML tags <tr> and </tr> on lines four and eight respectively refer to the start and end of a table row, with the intermediate lines five to seven giving the column headings of the table. Here, the heading of the first column of the table is empty, and the headings of the second and third columns are “Show” and “Seats Remaining”. Lines 11 and 12 of the JSP source code make a call to a database to retrieve details about the theatre shows that are entered on the database. This code is dynamic and the size of the table displayed by the Web browser depends on the number of shows retrieved by the database.

The code in lines 14 to 26 tells the Web browser 22 what to display in the first column of the table. If there are seats remaining for a particular show, a radio button 52 is displayed. If there are no seats remaining, then the table cell 54 remains blank. Lines 28 to 30 display the name of the show in the second column of the table, and lines 31 to 33 display the number of free seats for that particular show. The JSP source code 48 is easy to understand from a Web programmer's point of view, but may not necessarily be obvious to a Web designer who may have no experience of programming. A Web designer will usually use one of the WYSIWYG (What You See Is What You Get) Web designing packages that are on the market, and these do not expose the designer to the underlying code.

The code for producing the same Web page 32 using a preferred embodiment of the present invention is now discussed. The Web page 32 shown in FIG. 10 can be generated by the following workflow document which comprises an XML instruction 28 to make a call to a database, and an associated XSL-T formatting instruction 30:

```
<workflow>
    <task>
        <XML loc=“ConfReg::getSeats” resourceType=
        “DB”/> // XML instruction 28
        <XSL loc=“renderForm.xsl”/>
        // XSL formatting instruction 30
    <task>
</workflow>
```

The processing of the workflow document is now described. Firstly, the workflow document is parsed to obtain the XML instruction 28. The XML instruction is then executed by the workflow processor 25. The XML instruction 28 includes a “resource type” which is specified as a database call (“DB”). The “loc” attribute of the XML instruction 28 is expressed in the form class::method. In this example ConfReg (short for conference registration) is the name of the class, and getSeats is the name of the class method to invoke. As the class is registered to the servlet, no path name or file location need be specified. The class “ConfReg” would be developed by a Web developer or programmer, including the code to read the data from the database, and for writing the code to create the XML code fragments that contain this data. Effectively, the Java code snippet (from Web Development with Java Server pages” by Duane K. Fields and Mark A. Kolb, Manning Publications 2000:

String sql=“SELECT * FROM SHOWS”;
ResultSet results = connection.executeQuery(sql);
While (results.next( )){

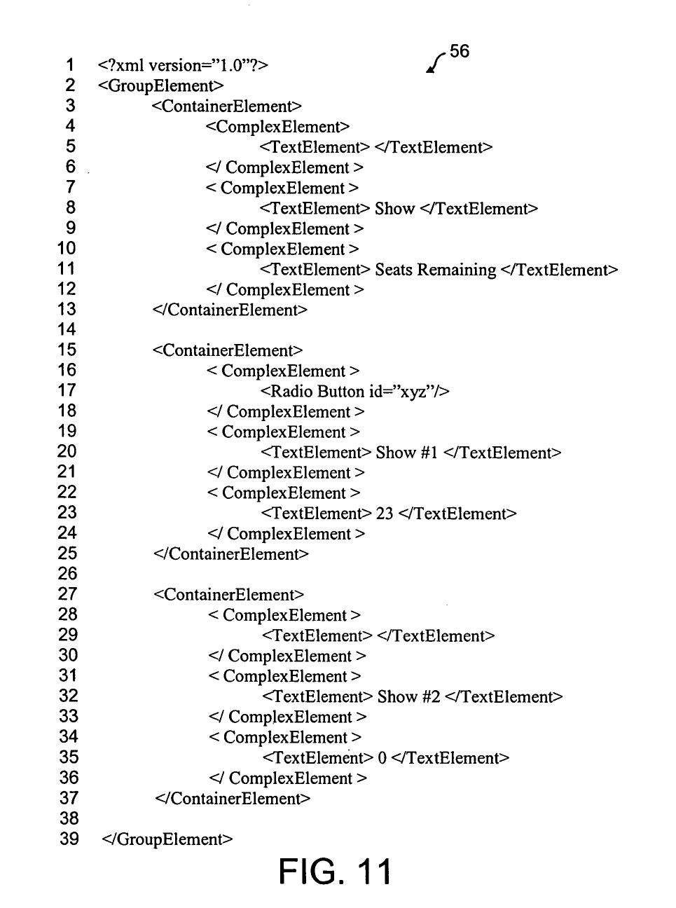

shown in FIG. 9 would be contained in this class method. The output of the class method call “getSeats” that is returned to the servlet 24 is the XML fragment 56 shown in FIG. 11.

The above workflow document illustrates that the design and formatting of the form 54 are completely separate from the programming logic and content of the form. In the preferred embodiment of the present invention, the programming logic is embedded in the class “ConfReg” and method “getSeats”, and the styling and formatting is provided in the XSL file. The Web designer therefore only needs to reference the class and call the methods that belong to the class. This is in contrast to the JSP page shown in FIG. 9, where Java code is embedded in the page.

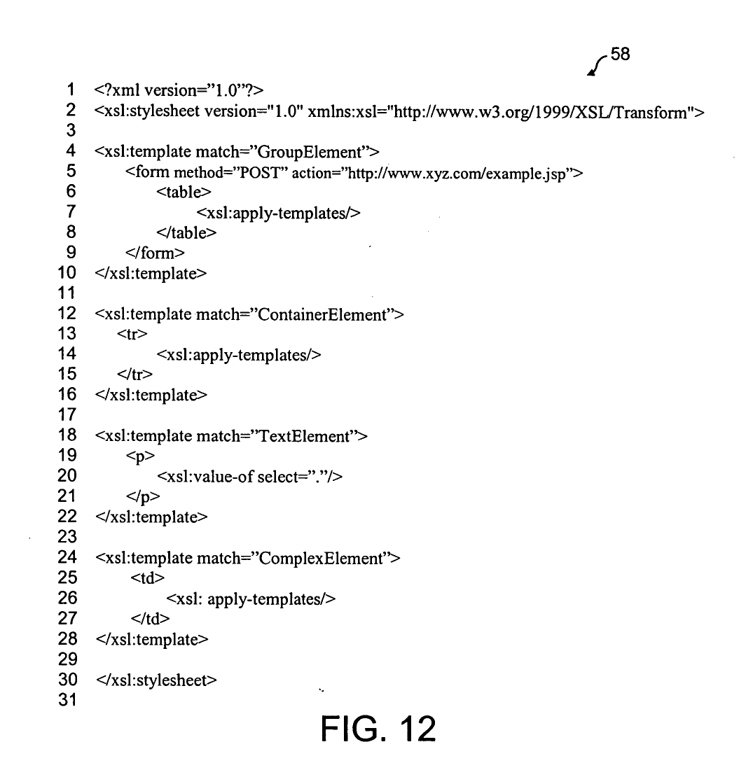

To format the XML fragment displayed in FIG. 11, the XSL-T file “renderForm” is called. The XSL-T stylesheet defined within this file is shown in FIG. 12. XSL is a declarative language based on template rules. Each template rule consists of a pattern and an action, and is specified with xsl:template. A detailed discussion of XSL-T will not be given here as this information is readily available to a skilled person.

In the example style sheet shown in FIG. 12, there are four template rules: “GroupElement”, “ContainerElement”, “TextElement”, and “ComplexElement”. The patterns for the four template rules are “GroupElement” which matches the <GroupElement> tags in the XML code fragment 56, “ContainerElement” which matches <ContainerElement> tags in the XML code fragment, and so on.

The actions for the rules are specified by the body of each rule. For example, the xsl:template for “ComplexElement” when applied to the XML fragment 56 creates the HTML tags <td> and <td> which define a table cell, whereas the xsl:template for “TextElement” simply inserts the body of the text element of the XML document into the HTML output.

If additional rows in the table 54 displayed in the Web browser 22 are returned by the database call, then the XSL-T stylesheet 58 will format them without any intervention from the Web designer. If different attributes are required, such as displaying the text in a certain font or colour, then this code may be easily added to the XSL-T file or a Cascading Style sheet (CSS). Note that no logic is applied inside the XSL-T file, only style and markup code are specified. This approach simplifies the separation of the roles of the Web developer or programmer and the Web designer who only need to agree the XML tags. Code and logic are isolated from the Web page authoring process.

A simplified version of the HTML code produced from the workflow document 26 is given in FIG. 13. When the complete HTML file is sent to the client 10, it appears as a Web page 32 that has the same content shown in FIG. 10. The Web page produced by the JSP code of FIG. 9 and the Web page produced from the workflow document 26 could possibly be identical, but this of course depends on Web browser settings and the formatting and styling instructions specified in the XSL-T style sheets.

Having described a particular embodiment of the present invention, it is to be appreciated that the embodiment in question is exemplary only and that variations and modifications such as will occur to those possessed of the appropriate knowledge and skills may be made without departure from the spirit and scope of the invention as set forth in the appended claims. For example, the invention may also be suitable for use in the presentation and processing of data from forms displayed in a Web browser. The response document need not be formatted in a form for rendering to a display screen, but may in fact be an XML document written to be consumed by a client running an application program other than a Web browser. The method of the invention is also not restricted to being carried out in a client-server environment. It may be carried out using a single computer, a network of computers, or any other suitable configuration of computers.

1. A method of dynamically generating a response document from a workflow document which comprises a plurality of a first type of workflow instructions for retrieving data, and a plurality of a second type of corresponding workflow instructions for converting the retrieved data into a plurality of markup language fragments, the method comprising:
processing a selected task of a workflow document using the first type of instruction of that selected task;
converting the results of the processing step into a markup language fragment using the second type of instruction of that selected task;
storing the markup language fragment in a response document; and
repeating the processing, converting and storing steps to create a completed response document comprising a plurality of markup language fragments.

2. A method according to claim 1, wherein the step of processing a selected task of the workflow document comprises parsing the workflow document, extracting the first type and the second type of workflow instructions from the selected task, and executing the first type of workflow instruction thereby retrieving data.

3. A method according to claim 1, wherein the processing steps are carried out for a predetermined sequence of tasks.

4. A method according to claim 1, wherein the repeating step comprises processing a next task prior to completion of processing of a current task.

5. A method according to claim 2, wherein the step of processing the first type of workflow instruction of the selected task comprises retrieving data from a database by making a database call.

6. A method according to claim 2, wherein the step of processing the first type of workflow instruction of the selected task comprises making a call to a further workflow document, embedded within the workflow document, and processing the further workflow document.

7. A method according to claim 1, wherein the processing step comprises retrieving data and the converting step further comprises embedding the retrieved data in intermediate code, such as a markup language code.

8. A method according to claim 1, wherein the converting step comprises converting a subset of the results of the processing step.

9. A method according to claim 1, wherein the converting step further comprises validating the results of the processing step.

10. A method according to claim 1, wherein the processing step further comprises receiving a request for a response document from a client of a client-server environment, retrieving the workflow document, and sending the workflow document to a workflow processor.

11. A method according to claim 1, further comprising inserting a hyperlink into the results of the processing step.

12. A method according to claim 1, further comprising inserting a digital signature into the results of the processing step.

13. A method according to claim 1, wherein the processing step and the converting step are carried out at a server-side of a client-server environment.

14. A method according to claim 1, wherein the processing step and the converting step are carried out at a client-side of a client-server environment.

15. A method according to claim 1, wherein the converting step comprises generating results in the form of a temporary code and subsequently converting the temporary code into a markup language fragment.

16. A method according to claim 1, wherein the converting step comprises receiving the data retrieved by executing the first type of workflow instruction, and executing the second type of workflow instruction, the executing step comprising applying a transform to the received data.

17. A method according to claim 16, wherein the step of executing the second type of workflow instruction further comprises retrieving an XSL document containing the transform.

18. A method according to claim 16, further comprising transmitting the response document to a client in a client-server environment for display in a Web browser.

19. A method according to claim 1, further comprising checking for an error in the workflow document and, if an error has occurred, inserting an error code into the response document identifying where in the workflow document the error has occurred and/or the type of error.

20. A method according to claim 1, wherein at least one of the second type of workflow instructions, associated with a corresponding first type of workflow instruction, comprises first and second sequential workflow instructions, and the converting step comprises implementing the first sequential workflow instruction on the results of the first type of workflow instruction and thereafter implementing the second sequential workflow instruction on the results of the first sequential workflow instruction.

21. A method according to claim 1, further comprising using a predetermined workflow document comprising the first and second types of workflow instructions to generate the workflow document for dynamically generating the response document.

22. A system for dynamically generating a response document from a workflow document which comprises a plurality of a first type of workflow instructions for retrieving data, and a plurality of a second type of corresponding workflow instructions for converting the retrieved data into a plurality of markup language fragments, the system comprising:
processing means for processing each of the first type of workflow instructions to generate a corresponding output;
conversion means for executing each of the corresponding second type of workflow instructions to convert each of the outputs of the processing means into one of the plurality of markup language fragments; and
a data store for storing each of the plurality of markup language fragments generated by the conversion means in the response document.

23. A system according to claim 22, wherein the processing means comprises a parser for parsing the workflow document to extract the plurality of first type of instructions and the corresponding plurality of second type of instructions for execution.

24. A system according to claim 22, wherein the plurality of first type of instructions comprise at least one XML instruction and the plurality of second type of instructions comprise at least one XSL or CSS format instruction.

25. A system according to claim 22, wherein the plurality of first type of instructions comprise at least one XML instruction and the plurality of second type of instructions comprises at least one XQuery operation.

26. A system according to claim 22, wherein the processing means and the conversion means comprise a workflow processor and the system further comprises a servlet for accessing the workflow processor.

27. A system according to claim 26, wherein the workflow processor and the servlet are arranged to communicate via a message queue.

28. A system according to claim 26, wherein the servlet is arranged to transmit the markup language fragments of the response document to a client in a client-server environment.

29. A system according to claim 22, further comprising a communications server for receiving a request for a response document from a client of the client-server environment, and means for retrieving the workflow document and passing the workflow document to the workflow processor.

30. A data carrier comprising a computer program arranged to configure a computer to implement a method according to claim 1.

31. A workflow document for use in a method according to claim 1, the workflow document comprising: a plurality of workflow tasks, each task comprising a first type of workflow instruction for retrieving data, and a corresponding second type of workflow instruction for converting the retrieved data into a markup language fragment.

32. A workflow document according to claim 31, wherein the first and second types of workflow instructions comprise code written in a markup language.

33. A workflow document according to claim 32, wherein the markup language comprises XML.

34. A workflow document according to claim 31, wherein the first type of workflow instruction specifies the type and location of the data to be retrieved.

35. A workflow document according to claim 31, wherein the workflow task specifies whether or not the task can be carried out asynchronously.

36. A workflow document according to claim 31, wherein the second type of workflow instruction specifies the location of a document that contains a transform for converting the retrieved data.

37. A workflow document according to claim 36, wherein the second type of workflow instruction comprises an XSL or CSS instruction.

38. A workflow document according to claim 36, wherein the second type of workflow instruction comprises an XQuery instruction.

39. A workflow document according to claim 31, further comprising conditional logic statements for determining which tasks are to be executed.

40. A method of designing a dynamic response document such as a Web page, the method comprising creating a workflow document including a plurality of workflow tasks, wherein the creating step comprises specifying a plurality of first type of workflow instructions for retrieving data and a plurality of second type of corresponding workflow instructions for converting the retrieved data into a corresponding plurality of commonly understood format language fragments.

41. A method according to claim 40, wherein the specifying step comprises selecting a first type of workflow instructions or a second type of workflow instructions from a predetermined library of such instructions.

42. A data carrier comprising a computer program arranged to configure a system according to claim 22.

43. A method of dynamically generating a response document from a workflow document which comprises a plurality of a first type of workflow instructions for retrieving data, and a plurality of a second type of corresponding workflow instructions for converting the retrieved data into a plurality of markup language fragments, the method comprising:
processing a selected task of a workflow document using the first type of instruction of that selected task;
converting the results of the processing step into a markup language fragment using the second type of instruction of that selected task;
storing the markup language fragment in a response document; and
repeating the processing, converting and storing steps to create a completed response document comprising a plurality of markup language fragments, wherein at least one of the second type of workflow instructions, associated with a corresponding first type of workflow instruction, comprises first and second sequential workflow instructions, and the converting step comprises implementing the first sequential workflow instruction on the results of the first type of workflow instruction and thereafter implementing the second sequential workflow instruction on the results of the first sequential workflow instruction.

44. A method of dynamically generating a response document from a workflow document which comprises a plurality of a first type of workflow instructions for retrieving data, and a plurality of a second type of corresponding workflow instructions for converting the retrieved data into a plurality of markup language fragments, the method comprising:
processing a selected task of a workflow document using the first type of instruction of that selected task;
converting the results of the processing step into a markup language fragment using the second type of instruction of that selected task;
storing the markup language fragment in a response document; and
repeating the processing, converting and storing steps to create a completed response document comprising a plurality of markup language fragments, the repeating step further comprising processing a next task prior to the completion of processing of a current task.

45. A method of dynamically generating a response document from a workflow document which comprises a plurality of a first type of workflow instructions for retrieving data, and a plurality of a second type of corresponding workflow instructions for converting the retrieved data into a plurality of markup language fragments, the method comprising:
processing a selected task of a workflow document using the first type of instruction of that selected task;
converting the results of the processing step into a markup language fragment using the second type of instruction of that selected task;
storing the markup language fragment in a response document; and
repeating the processing, converting and storing steps to create a completed response document comprising a plurality of markup language fragments, the processing step further comprising making a call to a further workflow document, embedded within the workflow document, and processing the further workflow document.

46. A method of dynamically generating an XML document from a workflow document which comprises a plurality of XML code fragments for retrieving data, and a plurality of XSL transforms for formatting the retrieved data, the method comprising:
processing a selected task of the workflow document using the XML code fragments of that selected task to retrieve data, and embedding the retrieved data in a further XML code fragment;
formatting the further XML code fragments using the XSL transform of that selected task;
storing the formatted XML code fragments in a response document; and
repeating the processing, formatting and storing steps to create a completed XML document comprising a plurality of formatted XML code fragments.

47. A system for dynamically generating a response document from a workflow document which comprises a plurality of a first type of workflow instructions for retrieving data, and a plurality of a second type of corresponding workflow instructions for converting the retrieved data into a plurality of markup language fragments, the system comprising:
a workflow processor for processing each of the first type of workflow instructions to generate a corresponding output;
a workflow converter for executing each of the corresponding second type of workflow instructions to convert each of the outputs of the workflow processor into one of the plurality of markup language fragments; and
a data store for storing each of the plurality of markup language fragments generated by the workflow converter in the response document.
